(19) United States
(12) Patent Application Publication
(10) Pub. No.: US 2009/0022123 A1
(43) Pub. Date: Jan. 22, 2009

(54) Apparatus and method for providing contents sharing service on network

(75) Inventors: Su Young Bae, Daejeon (KR); Chang-Sik Cho, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/153,895

(22) Filed: May 27, 2008

(30) Foreign Application Priority Data
Jul. 16, 2007 (KR) 10-2007-0071020

(51) Int. Cl. H04Q 7/24

(52) U.S. Cl. 370/338

(57) ABSTRACT

The present invention relates to a network-based contents sharing service providing device and method. A contents provider stores at least one content in a memory and manages it, classifies information on shared contents to be shared with the contents receiver according to a predetermined reference, generates a shared contents list by making information on the classified shared contents into a list, manages the list, and provides the shared contents list to the corresponding contents receiver when there is a contents receiver for sharing shared contents from among the contents receivers in the service area in which the contents provider is positioned. A contents receiver presents the shared contents list to the contents receiving user, receives at least one shared content from the contents provider through downloading or streaming according to selection of the contents receiving user having acquired the list, and performs it. Accordingly, the contents receiving user can freely use various contents of the contents provider positioned in the service area such as his portable terminal.

### CROSS-REFERENCE TO RELATED APPLICATION

This application claims priority to and the benefit of Korean Patent Application No. 10-2007-0071020 filed in the Korean Intellectual Property Office on Jul. 16, 2007, the entire contents of which are incorporated herein by reference.

### BACKGROUND OF THE INVENTION

(a) Field of the Invention

The present invention relates to a mobile communication system. More particularly, the present invention relates to a device and method for shared is contents in a terminal.

(b) Description of the Related Art

In general, contents represent various types of information or corresponding data that are generated by producing, processing, and providing characters, signs, speech, sound, images, and video through digital processing for wired/wireless communication networks. That is, the contents include various categories of pictures, videos, movies, and music files that users can easily find on the Internet in everyday life.

However, as an example, in order to promote contents (e.g., company and product promotions, and video for sales) to many consumers, a contents provider requires various skills and hardware including an Internet web server and an Internet access program. That is, not everybody can easily provide contents.

Accordingly, agency web sites for receiving contents from providers who desire to post contents and post them on the Internet have increased, which causes the contents providers and receiving users (consumers) to pay a commission, and which has many consumption sides.

Therefore, methods for substantially reducing the consumption sides in addition to the commission have been proposed, and one of them is the method for a user to share the contents stored in the terminal of the user with other users. That is, when a contents providing terminal gives an access right to a contents receiving terminal, the contents receiving terminal accesses a contents provider terminal, directly searches the contents stored in a database (e.g., a memory) in the contents provider terminal, and transmits the desired contents to the receiver terminal to be stored therein. The contents receiver terminal reproduces the stored contents so that the receiver may use the corresponding contents.

However, the above-noted contents sharing method has a problem for the contents provider and the receiver to manually perform all the processes from the start to the end. For example, the contents provider must individually set the access right so that a plurality of users may view the contents stored in the terminal of the contents provider, and the contents receiver must know the accurate network address in advance and must search the databases in the contents provider terminal respectively since he does not know where the desired contents are located.

In the prior art, there is a system for providing a service that accesses a large external server through a user terminal and uses the contents provided by a corresponding server or the contents stored in advance by the user.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a device and method for sharing contents of a terminal provided in the same service space.

In one aspect of the present invention, in a method for a contents provider connected to a contents receiver through a network to provide a service, a method for providing a contents sharing service includes: storing at least one content in a memory; classifying shared contents that can be shared with the contents receiver according to a predetermined reference from among the stored contents; generating a shared contents list including information related to the classified shared contents; searching whether there is a contents receiver for sharing the classified shared contents from among the contents receivers entering the network in which the contents provider is positioned; and presenting the generated shared contents list to the corresponding contents receiver according to the search result, and providing at least one shared content to the contents receiver according to the selection of the contents receiving user having acquired the presented shared contents list.

In another aspect of the present invention, a contents provider for providing contents to a contents receiver connected through a network includes: a contents classifier for classifying shared contents that can be shared with the contents receiver from among at least one content stored in a memory according to a predetermined reference; a shared contents list generator for generating a shared contents list including information related to the classified shared contents; a contents receiver searcher for searching whether there is a contents receiver for sharing the classified shared contents from among the contents receivers entering the network; and a shared contents provider for presenting the generated shared contents list to the corresponding contents receiver according to the search result, and providing at least one shared content to the contents receiver according to the selection of the contents receiving user having acquired the presented shared contents list.

In another aspect of the present invention, a contents receiver for receiving contents from a contents provider connected through a network includes: a contents provider searcher for searching whether there is a contents is provider for providing at least one content from among contents providers in the network in which the contents receiver is positioned; a shared contents list presenter for receiving a shared contents list including information on at least one content from the corresponding contents provider according to the search result, and representing the shared contents list; and a service provider for receiving at least one content from the contents provider according to the selection of the contents receiving user having acquired the presented shared contents list, and reproducing the at least one content.

In another aspect of the present invention, provides is a contents sharing service providing device including a contents provider and a contents receiver connected through a network wherein the contents provider acquires a request of a contents receiver entering the network in which the contents provider is positioned, searches the contents stored in a memory, and presents a shared contents list that is information related to the searched contents to the contents receiver, and the contents receiver generates the presented shared contents list into a predetermined list according to a predetermined reference, presents the list to the contents receiving user, receives at least one content from the contents provider according to the selection of the contents receiving user having acquired the presented shared contents list, and reproduces the at least one content.

According to the exemplary embodiment of the present invention, a contents receiver can freely search and use the contents of a contents provider in real-time through his terminal by allowing the contents receiver to share various contents of the contents provider located in the same service area. Further, the contents provider also increases contents usage by providing the contents stored in his terminal to the contents receiver, and thus increases service satisfaction through a predetermined commission.

### BRIEF DESCRIPTION OF THE DRAWINGS

FIG. 1 is a schematic diagram for a network-based contents sharing service providing device according to an exemplary embodiment of the present invention.

FIG. 2 is a detailed block diagram for the contents sharing service providing device shown in FIG. 1.

FIG. 3 is a flowchart for an operational process of the contents sharing service providing device shown in FIG. 2.

FIG. 4 is a screenshot of a contents provider displaying a shared contents list according to an exemplary embodiment of the present invention.

FIG. 5 is a screenshot of a contents receiver displaying a format-changed shared contents list according to an exemplary embodiment of the present invention.

FIG. 6 is a screenshot of a contents receiver displaying shared contents provided by a contents provider according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprising” and variations such as “comprises” will be understood to imply the inclusion of stated elements but not the exclusion of any other elements. Also, the terms of a unit, a device, and a module in the present specification represent a unit for processing a predetermined function or operation, which can be realized by hardware, software, or a combination of hardware and software.

Throughout the specification, a mobile station (MS) represents a terminal, a mobile terminal (MT), a subscriber station (SS), a portable subscriber station (PSS), user equipment (UE), and an access terminal (AT), and includes entire or partial functions of the mobile terminal, subscriber station, portable subscriber station, and user equipment.

A base station (BS) represents an access point (AP), a radio access station (RAS), a node B (Node-B), a base transceiver station (BTS), and a mobile multihop relay (MMR)-BS, and includes entire or partial functions of the AP, RAS, Node-B, BTS, and MMR-BS.

In the exemplary embodiment of the present invention, for better comprehension and ease of description, a user terminal for providing at least one content will be referred to as a contents provider, and a user terminal for receiving at least one content from the contents provider and executing the same will be called a contents receiver.

A network-based contents sharing service providing device according to an exemplary embodiment of the present invention will now be described.

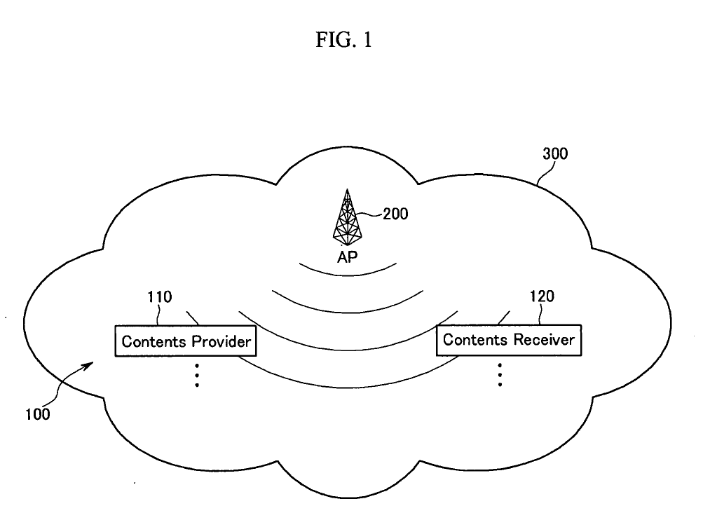

FIG. 1 is a schematic diagram for a network-based contents sharing service providing device according to an exemplary embodiment of the present invention.

As shown in FIG. 1, the network-based contents sharing service providing device 100 includes a contents provider 110 and a contents receiver 120. The contents provider 110 and the contents receiver 120 are located in a wired/wireless network 300 having a predetermined circle with reference to an access point 200, and are connected through the access point 200.

As described, the user terminal is classified as a contents provider and a contents receiver in the exemplary embodiment of the present invention, and in addition, the contents provider can be a contents receiver, and the contents receiver can be a contents provider.

The contents provider 110 and the contents receiver 120 include various portable devices for supporting the wired/wireless network 300, such as a personal digital assistant (PDA), a portable multimedia player (PMP), an ultra-mobile personal computer (UMPC), a notebook computer, a mobile station, and a PC.

In detail, the contents provider 110 periodically stores and manages at least one content by classifying the contents into contents that are shareable by the contents receiver 120 in the same service area (called “shared contents” hereinafter for better comprehension and ease of description) and contents that are not shareable by the contents receiver 120 (called “unshared contents” hereinafter).

The contents provider 110 generates and manages a shared contents list that is generated as a list for information related to the shared contents. The shared contents list includes basic information including a uniform resource locator (URL) of the shared contents, storage position, name, type (audio/video/image), size, format (mp3, avi, mp4, jpg, gif, png, etc.), and thumbnails (small pictures for displaying a rough image of the corresponding contents), and additional information including a tree for reconfiguring the shared contents according to storage positions based on the basic information, and contents that are systematized according to types of the shared contents.

The contents provider 110 searches whether there is a contents receiver 120 to which the shared contents must be provided or that has requested the shared contents from among the contents receivers that have entered the wired/wireless network 300 in which the contents provider 110 is positioned or that are already positioned, and the contents provider 110 provides a shared contents list to the corresponding contents receiver 120 based on the search result.

The contents receiver 120 determines whether the same shared contents as those selected by the contents receiving user are stored in advance in the contents receiver 120, or whether the shared contents selected by the contents receiving-user can/cannot be performed in the contents receiver 120 based on the provided shared contents list.

The contents receiver 120 receives the shared contents selected by the contents receiving user from the contents provider 110 through downloading or streaming according to the determined result, and then performs them, and hence the contents receiver 120 and the contents provider 110 share at least one content.

Accordingly, the contents provider according to the exemplary embodiment of the present invention acquires the request of the contents receiver that has newly entered the wired/wireless network in which the contents provider is positioned or that is already positioned in the wired/wireless network, and provides a shared contents list, and the contents receiver requests the shared contents selected by the contents receiving user from the contents provider based on the provided shared contents list, receives the corresponding contents in real-time, and performs them.

Hence, the contents receiving user can search and use desired contents from among various contents of the contents provider that is positioned in the same service area as the terminal of the contents receiver in real-time by using his terminal, and the contents provider can increase the usage of contents by providing the contents stored in the terminal of the contents provider to the contents receiver, thereby increasing service satisfaction through a predetermined commission acquired through the increase of usage of contents.

A detailed configuration of the contents sharing service providing device will now be described.

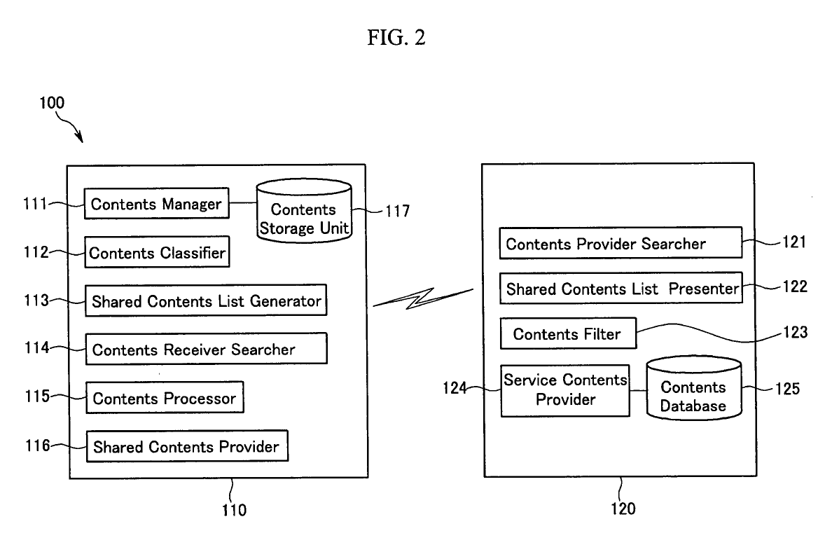

FIG. 2 is a detailed block diagram for the contents sharing service providing device shown in FIG. 1.

As shown in FIG. 2, the contents provider 110 includes a contents manager 111, a contents classifier 112, a shared contents list generator 113, a contents receiver searcher 114, a contents processor 115, a shared contents provider 116, and a contents database 117. The contents receiver 120 includes a contents provider searcher 121, a shared contents list presenter 122, a contents filter 123, a service provider 124, and a contents database 125.

The contents manager 111 of the contents provider 110 periodically stores and manages at least one content that is newly provided, added, updated, or deleted in the contents database 117, and the contents according to the exemplary embodiment of the present invention are interactive contents representing digital multimedia data including pictures, videos, and music files.

The wired/wireless network 300 applied to the embodiment of the present invention is not restricted to small volumes of networks such as offices and homes, and may include larger volumes of networks depending on the cases.

The contents classifier 112 classifies the at least one content stored in the contents database 117 as shared contents and unshared contents according to a predetermined classification rule. For reference, the contents stored in the contents database 117 are generally classified as shared contents, can also be classified as unshared contents depending on the cases. For example, when it is impossible to access the directory in which the contents are positioned or the contents (the case of having no access right such as reading or writing, and the case of a directory and file that are set to be protected by a manager or a user), the contents stored therein are classified as shared contents.

The shared contents list generator 113 generates information related to the shared contents into a shared contents list, stores the shared contents list in the contents database 117, and manages it.

The contents receiver searcher 114 searches whether there is a contents receiver to which shared contents must be provided or there is a contents receiver that desires to receive shared contents from among the contents receivers 120 that have entered the wired/wireless network 300 in which the contents provider 110 is positioned or that are already positioned in the wired/wireless network 300.

The contents processor 115 checks whether the shared contents selected by the contents receiving user are normally performed in the contents receiver 120, and then controls the size of the corresponding shared contents, reduces colors, and compresses the contents according to the specification of the contents receiver 120 based on the checking result.

The shared contents provider 116 provides the shared contents list to the contents receiver 120, and provides at least one shared content to the contents receiver 120 in real-time according to the selection items of the contents receiving user who has acquired the shared contents list.

The shared contents provider 116 settles and processes a predetermined provision fee and a commission of the at least one shared content provided to the contents receiver 120. In the exemplary embodiment of the present invention, a predetermined fee and a commission are settled and processed when the shared contents are provided, and further, the shared contents can be provided without cost in the present invention.

The contents database 117 stores at least one content that is new, added, or updated.

The contents provider searcher 121 of the contents receiver 120 searches whether there is a contents provider 110 for providing shared contents to the contents receiver 120 from among at least one contents provider 110 in the wired/wireless network 300 that the contents receiver 120 have newly entered or in which the contents receiver 120 is already positioned, and transmits a contents request signal to the contents provider 110 according to the search result.

The shared contents list presenter 122 displays the shared contents list provided by the contents provider 110 to the monitor of the contents receiver 120 after having structured the shared contents list.

The contents filter 123 performs a filtering process for checking whether the same contents as the shared contents selected by the contents receiving user are stored in the contents database 125, determines whether the shared contents can be normally operated in the contents receiver 120 according to the filtering result, and processes the corresponding shared contents according to the determination result.

The service provider 124 receives the shared contents selected by the contents receiving user from the contents provider 110 through downloading and reproduces them, or receives and reproduces the same through streaming, and then settles and processes the usage fee and commission of the reproduced shared contents.

The contents database 125 stores at least one content that is new, added, or updated.

A method for providing a contents sharing service according to an exemplary embodiment of the present invention based on the above-described contents sharing service providing device will now be described.

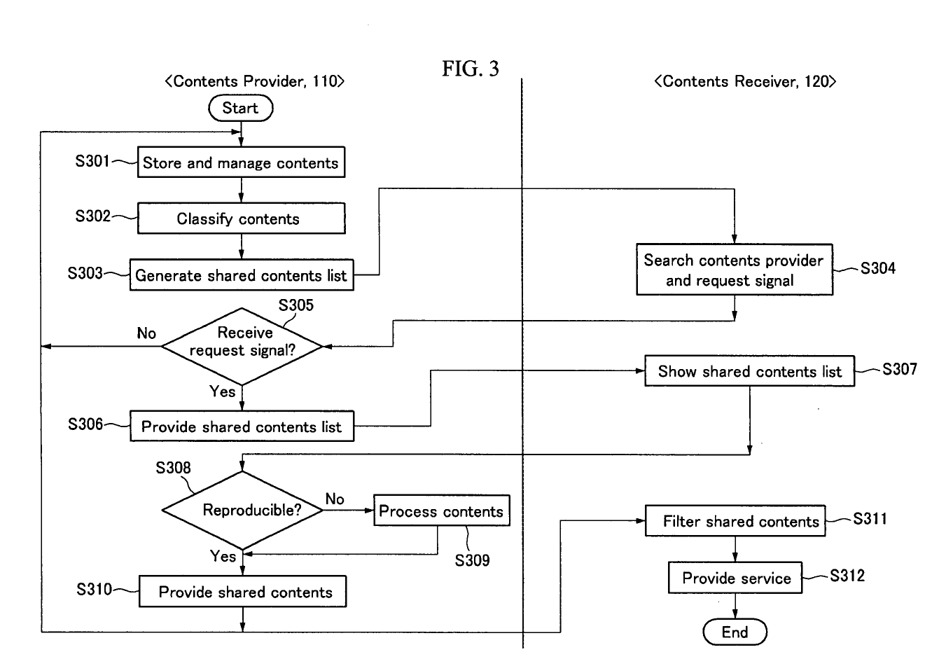

FIG. 3 is a flowchart for an operational process of the contents sharing service providing device shown in FIG. 2.

As shown in FIG. 3, the contents manager 111 of the contents provider 110 periodically stores at least one content that is new, added, updated, or deleted in the contents database 117, and manages the same (S301). The contents classifier 112 shares the contents stored in the contents database 117 and classifies them as shared and unshared contents according to a predetermined classification rule (S302), and for reference, the contents stored in the contents database 117 are mostly classified as shared contents.

The shared contents list generator 113 generates a shared contents list that is generated by making information related to the shared contents as a list, stores the list in the contents database 117, and manages it (S303). According to the exemplary embodiment of the present invention, the shared contents list includes basic information including shared contents' URL, storage position, name, type (audio/video/image), size, format (mp3, avi, mp4, jpg, gif, png, etc.), thumbnail (when the shared contents are video or images), and additional information including a tree that is generated by reconfiguring the contents for respective storage positions based on the basic information or contents that are systemized according to contents types.

The contents provider searcher 121 of the contents receiver 120 searches whether there is a contents provider 110 for providing shared contents desired by the contents receiving user from among the contents providers 110 provided in the same service area as the contents receiver 120, and transmits a contents request signal to the corresponding contents provider 110 according to the search result (S304).

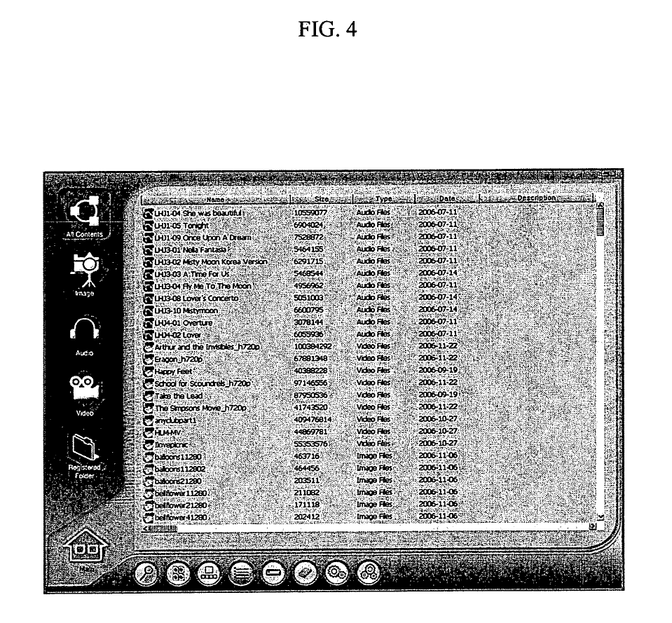

The shared contents provider 1 16 of the contents provider 110 provides the generated shared contents list to the contents receiver 120 according to the contents request signal provided by the contents receiver 120 (S306). For reference, FIG. 4 shows an example of the shared contents list provided to the contents receiver 120.

FIG. 4 is a screenshot of a contents provider displaying a shared contents list according to an exemplary embodiment of the present invention.

As shown in FIG. 4, the shared contents provider 116 presents the shared contents list including basic information having icons of the shared contents according to their types (image, audio, and video), file types, names, and generation dates, and additional information generated by having structured the shared contents according to types or positions to the contents providing user.

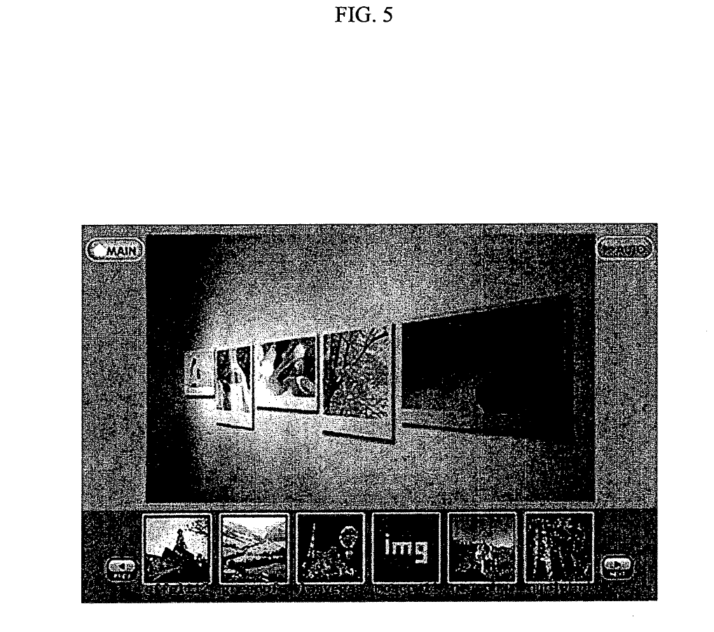

The shared contents list presenter 122 of the contents receiver 120 systemizes the shared contents list provided by the contents provider 110 into a predetermined list, and displays the list to the monitor (not shown) of the contents receiver 110 (S307), as shown in FIG. 5.

FIG. 5 is a screenshot of a contents receiver displaying a structured shared contents list according to an exemplary embodiment of the present invention.

When receiving a shared contents list (e.g., image name and size, URL, and thumbnail information) for the image contents requested by the contents receiving user from the contents provider 110, as shown in FIG. 5, the shared contents list presenter 122 systemizes the received shared contents list into a predetermined list and presents the list as a thumbnail format to the contents receiving user. Accordingly, the contents receiving user selects predetermined shared contents from the acquired shared contents list.

The contents processor 115 of the contents provider 110 checks whether the shared contents selected by the contents receiving user can be normally reproduced in the contents receiver 120 S308. When the shared contents cannot be normally reproduced, the contents processor 115 changes the size of the selected shared contents, reduces colors, and compresses the shared contents according to the specification of the contents receiver 120 (S309).

When the shared contents selected by the contents receiving user can be normally reproduced in the contents receiver 120, the shared contents provider 116 provides the corresponding shared contents to the contents receiver 110 in real-time (S310).

Accordingly, the contents filter 123 of the contents receiver 120 performs a filtering process for checking whether the same contents as the desired shared contents are stored in the contents database 125, and processes the corresponding shared contents based on the filtering result (S311). That is, in a like manner of the contents provider 110, the contents filter 123 checks the normal operation state of the desired shared contents.

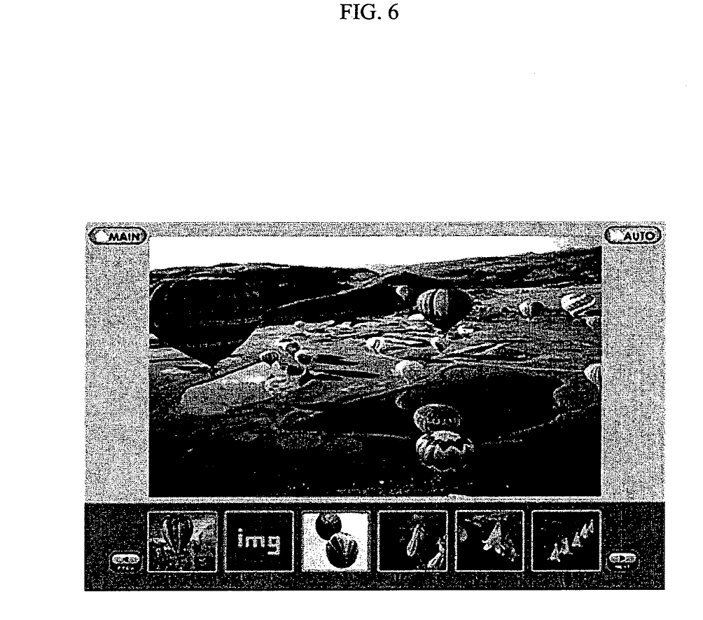

The service provider 124 receives the checked shared contents from the contents provider 110 and reproduces them, or receives them through streaming and then reproduces them (S312), as shown in FIG. 6.

FIG. 6 is a screenshot of a contents receiver displaying shared contents provided by a contents provider according to an exemplary embodiment of the present invention.

As shown in FIG. 6, the service provider 124 of the contents receiver 120 receives the shared contents (image) selected by the contents receiving user from the contents provider 110 through downloading, and displays the same to the monitor of the contents receiver 120.

The network-based contents sharing service providing device according to the exemplary embodiment of the present invention allows the contents receiving user to easily select and use the various contents of the contents provider that is positioned in the same service area as his terminal by using his terminal, and the contents provider also provides the contents stored in the terminal of the contents provider to the contents receiver, to thus increase the usage of contents and increase service satisfaction through a predetermined commission acquired through the increased usage of contents.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. In a method for a contents provider connected to a contents receiver through a network to provide a service, a method for providing a contents sharing service comprising:
storing at least one content in a memory;
classifying shared contents that can be shared with the contents receiver according to a predetermined reference from among the stored contents;
generating a shared contents list including information related to the classified shared contents;
searching whether there is a contents receiver for sharing the classified shared contents from among the contents receivers entering the network in which the contents provider is positioned; and
presenting the generated shared contents list to the corresponding contents receiver according to the search result, and providing at least one shared content to the contents receiver according to the selection of the contents receiving user having acquired the presented shared contents list.

2. The method of claim 1, further comprising:
checking whether the shared contents selected by the contents receiving user can be normally reproduced in the contents receiver; and
performing a process including at least one of controlling the size of the selected shared contents, reducing colors, and compressing the contents according to the checking result.

3. A contents provider for providing contents to a contents receiver connected through a network, comprising:
a contents classifier for classifying shared contents that can be shared with the contents receiver from among at least one content stored in a memory according to a predetermined reference;
a shared contents list generator for generating a shared contents list including information related to the classified shared contents;
a contents receiver searcher for searching whether there is a contents receiver for sharing the classified shared contents from among the contents receivers entering the network; and
a shared contents provider for presenting the generated shared contents list to the corresponding contents receiver according to the search result, and providing at least one shared content to the contents receiver according to the selection of the contents receiving user having acquired the presented shared contents list.

4. The contents provider of claim 3, wherein the contents provider further comprises a contents processor for checking whether the shared contents selected by the contents receiver can be normally reproduced in the contents receiver, and performing a process including at least one of controlling the size of the selected shared contents, reducing colors, converting the contents, and compressing the contents according to the checking result.

5. The contents provider of claim 3, wherein
the shared contents list includes:
basic information including at least one of a uniform resource locator (URL) of the shared contents, storage position, name, type, size, format, and thumbnail; and
additional information including at least one of a tree that is generated by rearranging the shared contents according to storage positions and contents that are generated by systemizing the shared contents according to types based on the basic information.

6. A contents receiver for receiving contents from a contents provider connected through a network, comprising:
a contents provider searcher for searching whether there is a contents provider for providing at least one content from among contents providers in the network in which the contents receiver is positioned;
a shared contents list presenter for receiving a shared contents list including information on at least one content from the corresponding contents provider according to the search result, and representing the shared contents list; and
a service provider for receiving at least one content from the contents provider according to the selection of the contents receiving user having acquired the presented shared contents list, and reproducing the at least one content.

7. The contents receiver of claim 6, wherein
the contents receiver further comprises a contents filter for checking whether the same contents as those selected by the contents receiving user are stored in the memory in the contents receiver.

8. The contents receiver of claim 6, wherein
the shared contents list includes:
basic information including at least one of a uniform resource locator (URL) of the shared contents, storage position, name, type, size, format, and thumbnail; and
additional information including a tree that is generated by rearranging the shared contents and contents that are generated by systemizing the shared contents based on the basic information.

9. A contents sharing service providing device including a contents provider and a contents receiver connected through a network, wherein:
the contents provider acquires a request of a contents receiver entering the network in which the contents provider is positioned, searches the contents stored in a memory, and presents a shared contents list that is information related to the searched contents to the contents receiver; and
the contents receiver generates the presented shared contents list into a predetermined list according to a predetermined reference, presents the list to the contents receiving user, receives at least one content from the contents provider according to the selection of the contents receiving user having acquired the presented shared contents list, and reproduces the content.
